(19) United States
(12) Patent Application Publication
(10) Pub. No.: US 2003/0191705 A1
(43) Pub. Date: Oct. 9, 2003

(54) Method and system for providing securities including a plurality of investment issues

(75) Inventors: Makoto Miyata, Yokohama (JP); Hiroshi Yoshikawa, Yokohama (JP); Chizuko Yasunobu, Tokyo (JP); Seiji Futatsugi, Kawasaki (JP); Takeshi Ieshima, Yokohama (JP)

Correspondence Address: McDermott, Will & Emery, 600, 13th Street, N.W., Washington, DC, 20005-3069, US

(73) Assignee: HITACHI, LTD

(21) Appl. No.: 10/301,834

(22) Filed: Nov. 22, 2002

(30) Foreign Application Priority Data
Apr. 4, 2002 (JP) 2002-102017

(51) Int. Cl. G06F 17/60

(52) U.S. Cl. 705/36

(57) ABSTRACT

As to investment issues which are selected by an investor as investment choices, an issue-wise investment amount which is weighted by reflecting issue-wise investment analysis information which is inputted by an analyst is calculated, and an operator incorporates quantity of issues for total investment amounts into securities.

### BACKGROUND OF THE INVENTION

This invention relates a method and a system for providing operation entrusting type securities (for example, investment trusts etc.) in which an investor entrusts a third party (for example, investment institutions etc.) with operation of funds, and in particular, a method and a system which is capable of realizing a highly transparent operation management by an action in which an investor who provides funds in securities selects issues which are set in the securities, with regard to an operation management of securities which operation is entrusted to a specialized investment institution as seen in the investment trusts.

In a security investment, it is vital to select investment choices (issues) appropriately and to manage the investment choices by diversifying them on some level and configuring a portfolio. Firstly, by diversifying the investment choices, change (risk) of fair values among the investment choices is balanced out and it is possible to return an entire risk as compared with a case in which investments are carried out individually. However, in order to carry out diversified investment, it is necessary to prepare a lot of funds for investing in many issues, and therefore, there is an aspect that it is hard for a tape watcher to do such a thing. Secondly, the portfolio once configured should not be continued to be held by fixing the issues and resource distribution ratios, and it is necessary to adjust appropriately the issues and resource distribution ratios of investment choices in conformity to economic circumstances from time to time. However, it is sometimes difficult for an investor who can not watch the market at all time to carry out the adjustment of the resource distribution without delay. A financial commodity which was developed for solving these two problems is the investment trust.

The investment trust is of a mechanism in which the specialized investment institutions and so on which collected funds from many investors operate them and distribute results of their operations to the investors in accordance with amount of funds. A major role of the investment institution is to carry out investigations and analyses relating to economics or securities market and to carry out a selection of issues such as appropriate stocks, and bonds and debentures, and a resource distribution. Further, it is legally obliged to disclose investors information of issues to be incorporated and so on as to a situation of operations. The investors can enjoy a risk reduction effect due to the above-described diversified investment, by investing in the investment trusts, and further can entrust specialized institutions of asset management with selection of issues and resource distributions.

However, the followings are not considered in the conventional mechanism of the investment trust. Considering from the view point of an investor who provides funds in the investment trust, it is desirable to grasp at pleasure and completely which issues and how much he/she is substantially investing in. On the other hand, considering from the view point of a fund manager who carries out operations, disclosing the contents of operations means to give away secrets so that disadvantages in the operations may be invited, and further, a large amount of labors and costs are required to carry out reports of the operations, and therefore, it is desirable not to carry out the information disclosures as far as possible. In current reports of operations, it is general to disclose schematic information within a scope defined in a law in ex post manner, and it is in a difficult situation to obtain transparency relating to contents of operations which are necessary for investors to make investment analysis relating to investment trusts.

For example, in order to enlarge the results of operations of the investment trust, it would appear to be a possibility that issues which an expected earning rate is high but which variation ratio of assessed values is high (high risk-high return) are incorporated aboundingly against intentions of investors. Further, since contents of buying and selling are not disclosed adequately, a possibility that illegal orders of buying and selling (dressing buying) are carried out to intentionally increase assessed values of investment trusts can not be excluded. Furthermore, in case of a investment trust in which an operation policy (emphasized investment in IT related issues and so on) is disclosed on some level, it would appear to be also a possibility that issues which are expected to be incorporated in the investment trust are purchased in expectation by another investor, prior to a trust setting date when operations are initiated.

In conventional investment trusts, investment institutions and so on (including fund managers) determine issues to be incorporated, and there is no investment trusts in which investors decide issues to be incorporated.

### SUMMARY OF THE INVENTION

The purpose of the invention is to provide a method and a system in which an investor who invests in operation entrusting type securities (for example, investment trusts etc.) can improve transparency of information relating to contents of operations which are necessary for making investment analysis.

The invention, as to securities including a plurality of investment issues, receives investment analysis which are decided by an analyst and for deciding an investment for individual investment issues, receives a plurality of investment issues and amount of funds for their plurality of investment issues and investment ratios corresponding to the investment analysis, which are designated by an investor, calculates investment amount of individual investment issues which are included in the plurality of investment issues based upon the amount of funds and the investment ratios, and outputs the investment amount of individual investment issues. In addition, in place of the investment ratio by the investor, an investment ratio based on investment analysis of an analyst may be utilized.

According to the invention, there is an advantage that transparency necessary for the investor who provides funds in securities to make investment analysis is improved.

Further, according to the invention, there is an advantage that satisfaction level of the investor who wishes to select issues to be invested by himself/herself is improved.

### BRIEF DESCRIPTION OF THE DRAWINGS

The invention, together with further advantages thereof, may best be understood by reference to the following description taken in conjunction with the accompanying drawings in which:

FIG. 1 is a flow chart showing processing of an embodiment of the invention;

FIG. 2 is a whole structural view of the embodiment of the invention;

FIG. 3 is a data row of an investment issue data base 221 of the invention;

FIG. 4 is a data row of an investment issue data base 222 of the invention;

FIG. 5 is an example of a screen for displaying at a terminal 202 of the invention;

FIG. 6 is a flow chart showing processing of calculation of investment amount by issues; and

FIG. 7 is a view showing a flow of funds of investors, trustees, and operators of the invention.

### DETAILED DESCRIPTION OF THE PREFERRED EMBODIMENTS OF THE INVENTION

An embodiment of the invention is characterized by having a unit adapted to obtain information of a funding amount of an investor, a unit adapted to obtain information of issues which are inputted by the investor as investment choices, a unit adapted to obtain information of issue-wise investment analysis, and a unit adapted to distribute the funding amount by the issues at an investment ratio (weight value) which reflects the information of the issue-wise investment analysis and to calculate an investment amount by issues. Hereby, it is possible to provide operation entrusting type securities in which an investor can select investment issues.

Since the investor selects the issues, a possibility that issues which are not desired by the investor are incorporated in the operation entrusting type securities is excluded. Further, an operator is requested to carry out buying and selling by just the amount of money which was calculated by an operation system, and a possibility of illegal buying and selling such as the dressing buying is excluded. Furthermore, in case that the contents of operations within a scope relating to respective investors are disclosed only to the investors, transparency which is adequate for making investment analysis is secured. Accordingly, in the light of transparency of the operation contents for investors, there is no necessity to carry out the information disclosure more than a legal scope, as to a composition ratio by issues and a resource distribution ratio of entire funds which are configured by securities of the invention, and operational drawbacks are avoided. Further, since a policy for carrying out a resource distribution from investment analysis is clearly indicated, there is an advantage that it is easy for investors to understand the policy of operations.

In a decision of an investment amount by issues, it is desirable to use weighted ratios reflecting information of investment analysis by issues which were prepared by specialized analysts and so on, and it is possible for investors to utilize the information of investment analysis prepared by the specialists. Further, since issues of investment choices and resource distribution ratios are appropriately adjusted in conformity to economic circumstances from time to time, it is desirable to add means for re-calculating the issue-wise investment amount in conformity to changes of issue-wise investment analysis, and it is possible to adjust the resource distribution to the issues appropriately in case that the investment analysis were changed. Further, in case that it is made to be possible that respective investors select analysts who make investment analysis, it is possible to give investors flexibility and feeling of consent in the investment analysis. In case that the investment analysis is made by many analysts, there is an advantage that a market impact in case that one analyst changed his/her investment analysis (advantages in which orders of buying and selling cause price fluctuation) is returned. Further, in case that a unit adapted to carry out buying and selling of issues by an issue-wise investment amount which was calculated is realized by a computer program and so on, it is possible to carry out prompt and small cost operations.

An institution which is entrusted with securities in the invention can carry out management of securities by a method which applies securitization as follows. The institution decides a whole or a part of financial resources entrusted by investors is set as face values thereof. The institution prepares securities in which an entire incorporating ratio as to issues which were selected by investors taking a selected ratio into consideration is determined. The institution entrusts operations of the securities to operators. The institution redeems the investors results of the operations in accordance with the selected issues and the ratio when a predetermined operation term is expired.

Here, the securities mean a financial commodity in which an investor entrusts a third party (for example, investment institutions etc.) with operations of funds, and for example, investment trusts and so on. The investor means a person who invests funds and capitals in marketable securities and so on, with the aim of acquirement of income gain such as profits and dividends and acquirement of capital gain through buying and selling actions. An analyst 231 means a person who provides an analysis of investment value of investment grade commodities, based upon investment theories, financial analyses, interviews with executives and so on. The operator means a person who purchases investment issues from a financial market, and for example, a fund manager. The investment institution and so on operate funds which are collected from investors (invest in investment issues) and return results of the operations to the investors as profits and dividends in accordance with the funding amount. The investment institution and so on make a profit by obtaining commission charges from investors in accordance with the number of buying and selling with investors, amounts of the buying and selling, and results of operations. On the other hand, an investor can make a profit not only by profits and dividends (income gain) of operation entrusting type securities from investment institutions and so on, but also by selling out (termination of securities) (capital gain) at a high price the operation entrusting type securities which were purchased at a popular price. The investment issues mean marketable securities such as stock certificates, debenture certificates, and investment trusts.

Hereinafter, embodiments of the invention will be described in detail based upon the drawings.

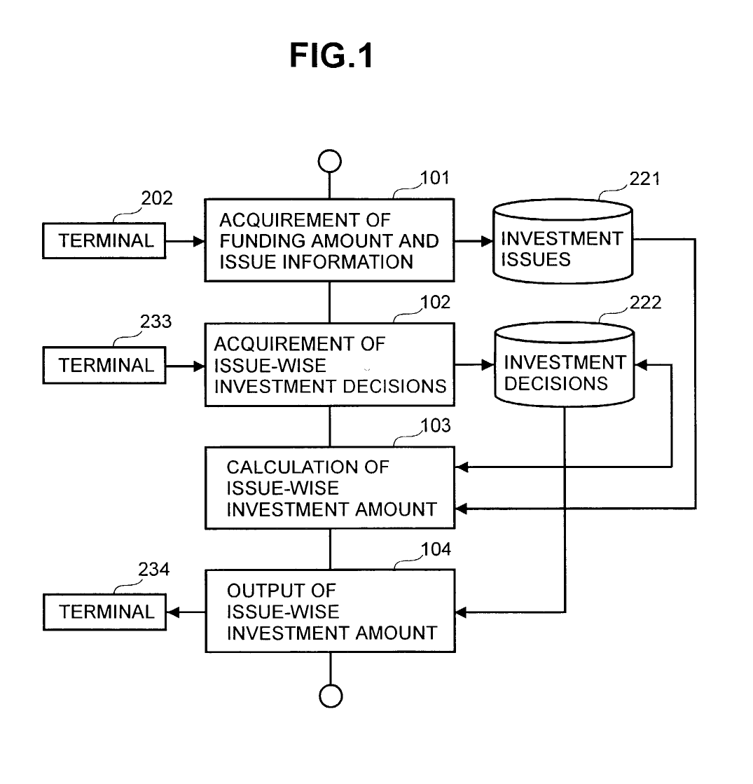

FIG. 1 is a flow chart for deciding an issue-wise investment amount (distribution amount) of the embodiment.

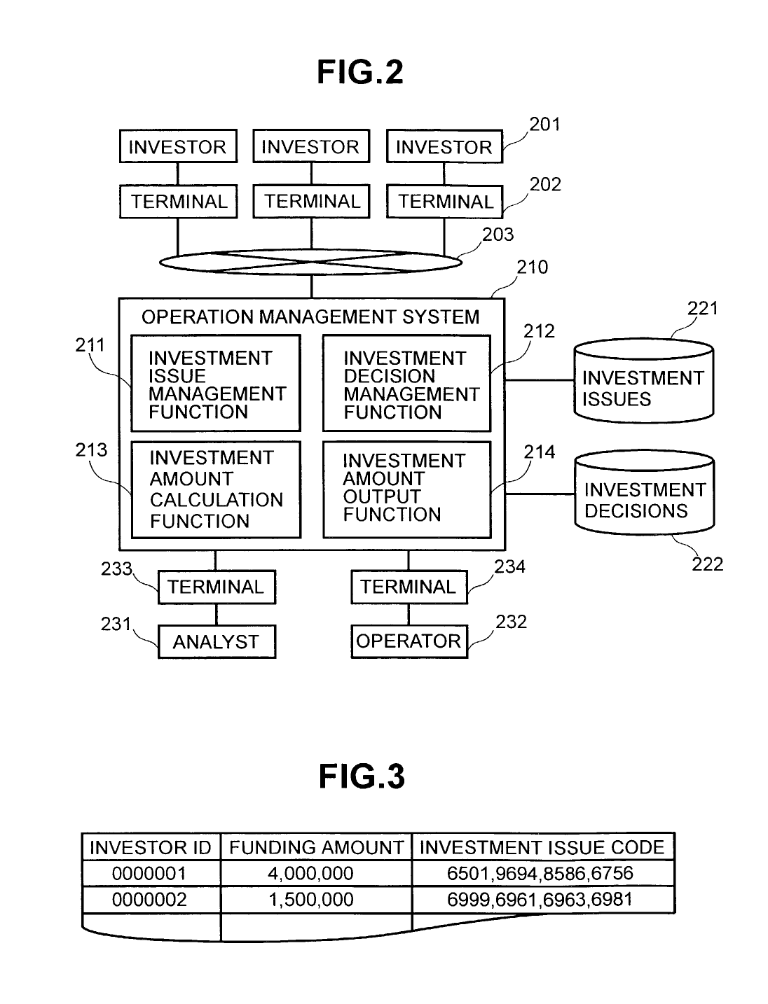

FIG. 2 is a whole structural view of a system of the embodiment. A system of the embodiment has a terminal 202 which an investor 201 uses, an operation management system 210 which an investment institution and so on use and which manages information relating operation entrusting type securities, an investment security database 221 which stores funding amounts and investment issues with respect to each investor 201, an investment analysis data base 222 which stores investment analysis and weight values with respect to each investment issue, a terminal 233 which an analyst 231 uses, and a terminal 234 which an operator 232 uses. It is preferable that the terminal 202, the terminal 233 and the terminal 234 are information processing apparatuses such as personal computers, portable telephones, and portable information terminals, and they are preferably provided with a central processing unit (CPU), a memory device (e.g., RAM, a hard disk), a communication device, an input device (e.g., a keyboard, a mouse), and a display device. It is preferable that the operation management system 210 has a central processing device (CPU etc.), a memory device (RAM and a hard disc etc.) and a communication device. It is preferable that the investment issue data base 221 and the investment analysis data base 222 have memory devices. It is preferable that, in the operation management system 210 and the terminals 202, 233 and 234, the central processing device carries out a predetermined processing, in accordance with a program which is stored in the memory device. For example, it is possible for the operation management system 210 to carry out the flow chart of FIG. 1, according to the program. The terminal 202 which is an input/output interface of the investor 201 and the operation management system 210 are connected by a communication network 203 such as wired or wireless Internet, and dedicated lines, and they can transmit and receive information (data) each other. Further, the operation management system 210, the terminal 202, the investment issue data base 221, the investment analysis data base 222, the terminal 233 and the terminal 234 are connected one another. The operation management system 210 has an investment issue management function 211, an investment analysis management function 212, an investment amount calculation function 213, and an investment amount output function 214. In addition, if the above-described functions can be realized, a part or whole of the above-described structure may be divided into a plurality of functions or unified as a single function. The analyst 231 and the operator 232 may be the same person, respectively or may be shared by a plurality of persons, and may be replaced by means which does not use man-powers such as a computer program. In case that tellers and sales persons of investment institutions and so on deal with investors, the tellers and the sales persons may use the terminal 202. The investment issue data base 221 may be of a mode that data is stored in a memory which is disposed in the terminal 202.

FIG. 3 is a data structure view of the investment issue data base 221 of the embodiment. The investment issue data base 221 stores an investor ID for identifying the investor 201, a funding amount which the investor 201 invests in the operation entrusting type securities, and a issue code for identifying the investment issue which was selected by the investor 201 in association with one another. In case that 1 operation entrusting type security is provide to 1 investor, it is preferable that funding amounts and issue codes are associated with respect to each investor ID, and in case that a plurality of operation entrusting type securities are allowed to be provided to 1 investor, by use of a security ID in addition to the investor ID, it is preferable that funding amounts and issue codes are associated with respect to each security ID.

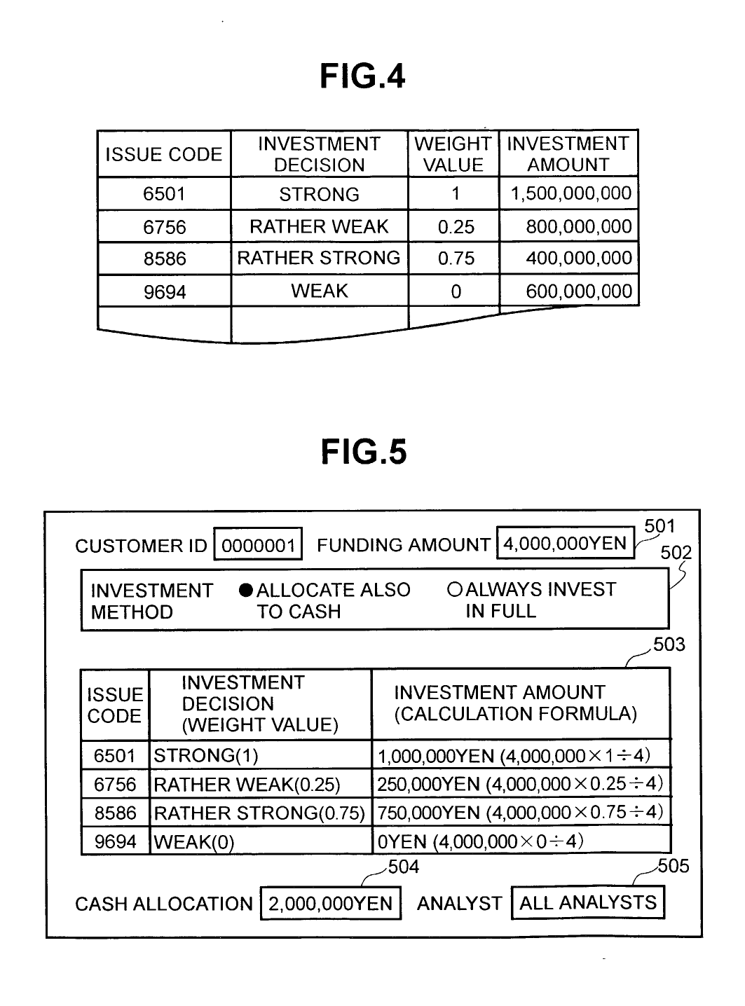

FIG. 4 is a data structure view of the investment analysis data base 222 of the embodiment. The investment analysis data base 222 stores issue codes, issue-wise investment analysis, and weight values which are weighted ratio for calculating investment amount from investment analysis in association with one another. The investment analysis are of five levels (may be more than or less than this) of for example, “STRONG, “RATHER STRONG, “NEUTRAL”, “RATEHR WEAK, and “WEAK and rated qualitatively, and weight values are assigned as to each level. In case of the qualitative rating, investors can recognize levels and weight values viscerally. The weight values are set that for example, STRONG is 1, RATHER STRONG is 0.75, NEUTRAL is 0.5, RATHER WEAK is 0.25 and WEAK is 0. The weight value is utilized as a coefficient for distributing the resources of investors in the investment issues. The investment analysis and the weight values are linked, and it is preferable that the investment analysis changes from WEAK toward STRONG as the weight value is increased. However, a method described herein for determining the investment analysis and the weight values is of exemplification, and it is not limited to the method. For example, there may be an embodiment in which respective investors 201 can set the weight values freely. That is, the, investor 201 registers the weight values for investment analysis in the operation management system 210, through the terminal 202. There may bean embodiment in which the analyst 231 and the operator 232 can set the weight values freely. That is, the analyst 231 or the operator 232 registers the weight values for investment analysis in the operation management system 210, through the terminal 233 or the terminal 234. Alternatively, the weight value in case that the investment analysis is STRONG may be set to be smaller, and the weight value in case of NEUTRSL may be set to be bigger. Alternatively, there may be a method for setting the weight values in recognizing changes of the investment analysis, in such manner that the weight values are made bigger for a certain period after the investment analysis is changed from WEAK to NEUTRAL. Alternatively, there may be an embodiment in which negative numeric values are included in the weight values and short selling (hitting upon by borrowing from others, without having stocks, or without using the stocks even if they are in possession) is possible. Further, in case that the investor 201 defines the weight values for the investment analysis, the investment analysis and the weight values are linked primarily, in such a manner that, in case that the investment analysis is of “STRONG the weight value is “1 and in case that the analyst 231 defines the weight values for the investment analysis, the weight values may be changed in accordance with the investment issues even when the investment analysis are identical, in such a manner that, even in case that the investment analysis is of “STRONG the weight value may be “or may be “0.9 ordance with the investment issues.

FIG. 5 is a structural view of a screen which is displayed at the terminal 202. The display screen of the terminal 202 is a screen which the investor 201 can take a look at. The display screen of the terminal 202 has a screen area for displaying the customer ID which identifies the investors 201, a screen area 502 for displaying investment methods of the investors 201 ( ALLOCATE ALSO TO CASH or “ALWAYS INVEST IN FULL, a screen area 501 for displaying the funding amount of the investor 201, a screen area 503 for displaying the issue codes of investment issues, investment analysis with respect to each issue, the weight values, the investment amount with respect to each issue and calculation formulas, a screen area 504 for displaying cash allocation amounts in case that the investor 201 selects “ALLOCATE ALSO TO CASH, and a screen area 505 for displaying the analyst which the investor 201 selected. It is preferable that the customer ID is identical to the investor 201 ID. The security ID may be displayed in addition to the customer ID. The operation management system 210 can accept increase (capital increase) or decrease (termination) of the funding amount, from the investor 201 through the terminal 202, and the funding amount in the screen area 501 is increased and decreased in accordance with the increase and decrease thereof. The operation management system 210 can accept an intention of reinvestment of profits or dividends of the operation entrusting type securities, from the investor 201 through the terminal 202, and the funding amount in the screen area 501 changes in accordance with the profits and dividends thereof. The operation management system 210 can accept selection of “ALLOCATE ALTO TO CASH or “ALWAYS INVEST IN FULL, from the investor 201 through the terminal 202. The “ALLOCATE ALSO TO CASH means a case that the investor 201 leaves a part of the investment amount as cash without investing it in the investment issues in full. In this case, a balance amount which the cash allocation amount is subtracted from the investment amount is invested in the investment issues. The “ALWAYS INVEST IN FULL means a case that the investor 201 invests full amount of the funding amount in the investment issues. In this case, the cash allocation amount becomes zero. In addition, the operation management system 210 may invest the cash allocation in commercial commodities of capital-safe type or may give the investor 201 a profit in accordance with the cash allocation amount based upon a predetermined interest rate.

Then, the processing of the security operation management system of the invention will be described by use of FIG. 1.

It is preferable that the operation management system 210 provides a list of all investment issues which are handled by the operation management system 210 (which can be selected by the investor 201) and their issue codes to the terminal 202. The terminal 202 displays the list on the display screen.

<Step 101>

The terminal 202 accepts an input of the funding amount and issue information from the investor 201. The issue information is information relating to the investment issues of the investor 201, and it is preferable that it is 1 or a plurality of issue codes or 1 or a plurality of issue names. Further, the terminal 202 may accept a selection of investment methods and an input of the cash allocation amount from the investor 201 and a selection of the analyst, and in case that the investor 201 defines the weight values, it may accept the weight value for the investment analysis from the investor 201. The investment issue management function 211 obtains the investment amount and the issue information (further, investment method, cash allocation amount and name of analyst which were inputted) which were inputted by the investor 201 at the terminal 202, through the communication network 203, and stores them in the investment issue data base 221. In case that there was an input of the weight value for the investment analysis from the investor 201, the investment issue management function 211 stores the weight value for the investment analysis from the investor 201 in the investment analysis data base 222.

<Step 102>

The terminal 233 accepts an input of the investment analysis from the analyst 231. In case that the analyst 231 defines the weight values, it is preferable that the terminal 233 accepts an input of the weight values for the investment analysis of the analyst 231 or the weight values with respect to each investment issue. The investment analysis management function 212 obtains the investment analysis which is inputted by the analyst 231, and stores them in the investment analysis data base 222. In case that the analyst 231 defines the weight values, the investment analysis management function 212 stores the weight values for the investment analysis of the analyst 231 or the weight values with respect to each investment issue in the investment analysis data base 222. In case that there are a plurality of analysts 231, it is preferable that the investment analysis management function 212 stores the investment analysis with respect to each analyst 231 in the investment analysis data base 222.

<Step 103>

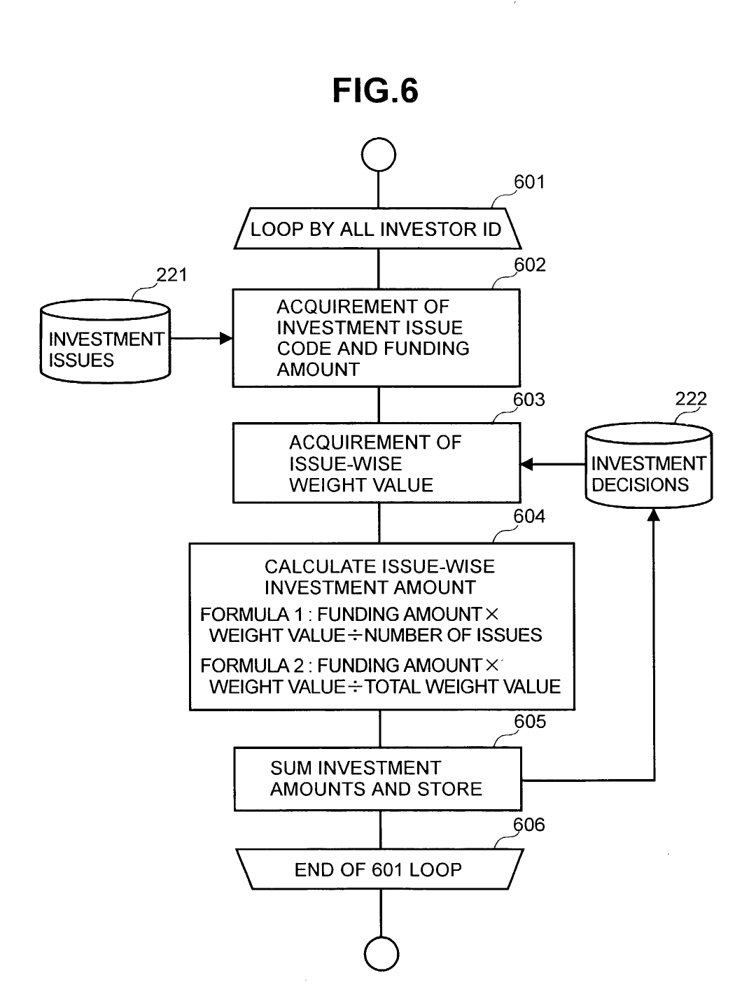

The investment amount calculation function 213 calculates the investment issue-wise investment amount. Hereinafter, details will be described by use of a flow chart for calculating the investment amount in the embodiment of FIG. 6.

A loop processing is carried out as to all investors who provide funds in securities of the invention in sequential order (step 601). As to one investor, the investment amount calculation function 213 obtains the investment amount and the investment issue code from the investment issue data base 221 (step 602). The investment amount calculation function 213, as to all issues which were obtained at the step 602, obtains the weight values for the investment analysis of their investment issues from the investment analysis data base 222 (step 603). The investment amount calculation function 213, as to respective investment issues, multiplies the investment amount which was obtained at the step 602 by the weight value of the investment issue which was obtained at the step 603, and divides it by the number of issues which were selected by the investor so that the issue-wise investment amounts are calculated (step 604). The calculation formula is, for example, (issue-wise investment amount)=(funding amount) ×(weight value)÷(number of issues). The investment amount calculation function 213 stores the issue-wise investment amounts which were calculated and the calculation formula for obtaining their investment amounts in the investment analysis data base 222 (step 605). In this case, in case that issue-wise investment amounts other than the investors have been already stored in the investment analysis data base 222, the investment amount calculation function 213 sums their investment amounts. Then, the investment amount calculation function 213 sums the issue-wise investment amounts of a plurality of investors which have been already calculated, and stores the total issue-wise investment amount, in addition to the issue-wise investment amounts with respect to each investor and the calculation formula for obtaining their investment amounts in the investment analysis data base 222. The forgoing proceeding is repeated from the step 602 (step 606). When the processing as to all investors is completed, the issue-wise total investment amounts have been stored in the investment analysis data base 222. The investment amount calculation function 213, as to respective investors, subtracts the total investment amount from the funding amount to calculate the cash allocation amount, and stores it in the investment analysis data base 222. The investment amount output function 214 transmits the cash allocation amount to the terminal 202, and the terminal 202 outputs it to the display area 504 of the display screen.

<Step 104>

The investment amount output function 214 outputs the issue-wise total investment amounts which are stored in the investment analysis data base 222 to the terminal 234. The terminal 234 outputs the issue-wise total investment amount to the, display screen, a printer and so on. The operator 232 purchases quantity of issues for the issue-wise investment amount which was outputted. In case that the operator 232 has already owned the quantity of issues more than the outputted investment amount, excessive quantity is sold. In case that buying and selling of the investment issues are realized by use of means such as a computer program, the system of the invention has a trading system for giving out to the market buying and selling orders for the quantity as to the investment issues. In case that a lot of selling orders or buying orders are carried out one time as for one investment issue, the market price of the investment issue changes largely, and therefore, it is preferable that the trading system gives out selling orders or buying orders to the market, by unit of a predetermined amount, by a predetermined interval, as for one investment issue. Hereby, it is possible to restrain that the market price of the investment issue changes largely.

Another calculation method of the issue-wise investment amount than one which was described at the step 103 may be, for example, a method for multiplying the investment amount of the investor 201 by the weight value of respective investment issues and for dividing it by total weight values of all issues which were selected by the investor 201. That is, (issue-wise investment amount)=(funding amount)×(weight value)÷(total weight value). According to this calculation method, all funding amounts are invested in issues, and are not allocated to cash. There may be an embodiment in which, in case that the investor selects the cash allocation in the screen area 502 of FIG. 5, the calculation method shown in the description at the step 103 is used, and in case that always investing in full is selected, the above calculation method is used.

There may be a single or a plurality of the analyst 231 which inputs the investment analysis at the step 102. In case of plurality, the investment analysis management function 212 may calculate a weight value for an average investment analysis and may store it in the investment analysis data base 222. The investment amount output function 214 reads out the weight value for the average investment analysis from the investment analysis data base 222, and transmits it to the terminal 202, and the terminal 202 outputs the weight value for the average investment analysis to the display area 503 of the display screen. Alternatively, in case that the investor uses preferentially the investment analysis which was inputted by the analyst 231 who was selected in the screen area 505 of FIG. 5, the issue-wise investment amount may be calculated based upon average value of the weight values which reflect only the investment analysis of the selected analyst 231. The terminal 202 accepts a selection of analysts from the investor 201, and transmits it to the operation management system 210, and the investment amount output function 214 reads out, from the investment analysis data base 222, the investment analysis which corresponds to the selected analyst and the weight value which corresponds to the investment analysis, and transmits them to the terminal 202, and the terminal 202 outputs the investment analysis and the weight value which correspond to the selected analyst to the display area 503 of the display screen. Further, the investment amount output function 214 reads out, from the investment analysis data base 222, the issue-wise investment amount corresponding to the investor which requested for display and its calculation formula, and transmits it to the terminal 202, and the terminal 202 outputs the issue-wise investment amount and its calculation formula to the display area 503 of the display screen.

In case that the terminal 233 accepted an input of changes of the issue-wise investment analysis by the analyst 231, the investment analysis management function 212 renews the investment analysis data base 222 in accordance with the changes, and after the investment amount calculation function 213 once resets the issue-wise investment amount of the investment analysis data base 222 (however, overwriting may be carried out without resetting), the processing is repeated from the step 102 so that the issue-wise investment amount is re-calculated, and issue-wise resource re-distributions are carried out, and the re-calculated issue-wise investment amount is stored in the investment analysis data base 222. That is, the investment amount calculation function 213 renews the investment analysis data base 222. In case that the investor 201 newly sets investment issues as investment choices or changes them, the investor changes the weight value, or the analyst changes the investment analysis or the weight value, the processing is repeated from-the step 101. That is, the investment issue management function 211 renews the investment issue data base 221, and the investment analysis management function 212 renews the investment analysis data base 222. In addition, even in case that there are a plurality of the investors 201, in case that one of the investors changed the investment issues, the weight values and the funding amounts, it is preferable that the investment amounts are re-calculated by the investment amount calculation function 213. This is because, even in case that one investor changed, the investment amount changes.

Further, the system of the invention may have an operation result calculation function for calculating results of operations in accordance with a plurality of investment issues and the investment ratio, in case that a predetermined operation term is expired, and an operation result output function for outputting the results of operations.

Then, processing at the side of a trustee of securities, after the investor purchases securities of the invention, will be described.

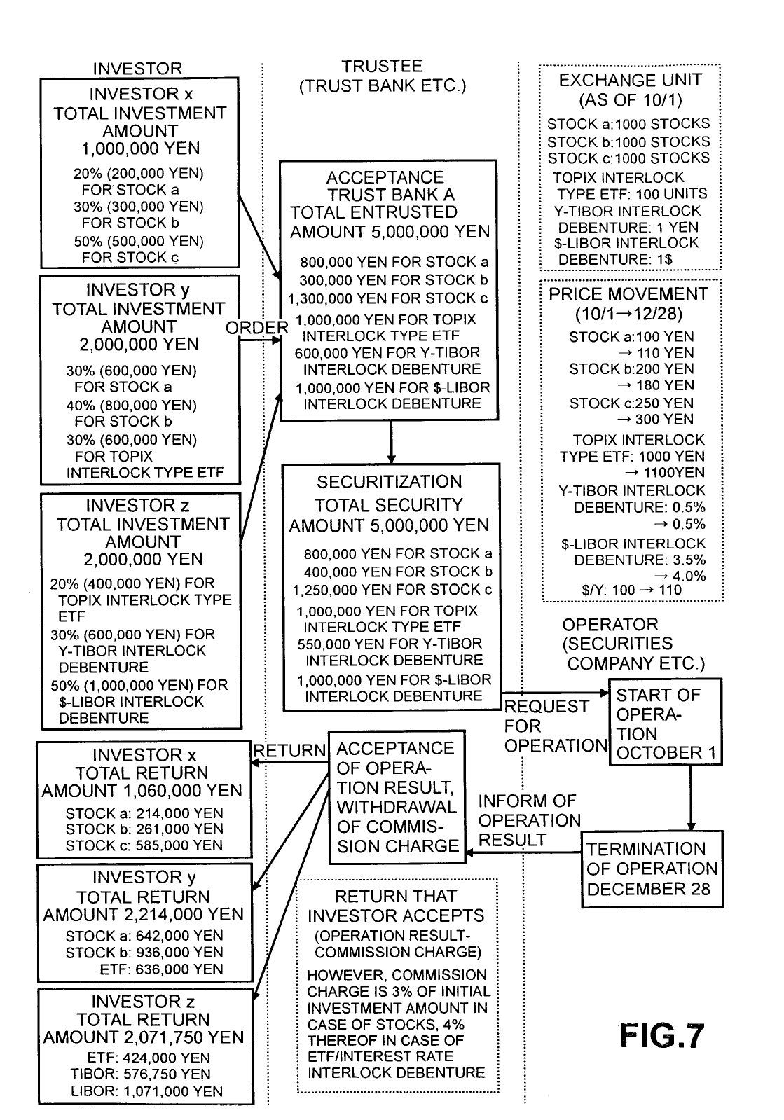

FIG. 7 is a schematic view showing a flow of funds among an investor, a trustee and an operator according to the invention.

The investor sends a list of issues which were selected by himself/herself and investment money to the trustee. As described above, unit of exchange (for example, the number of unit stocks of a stock certificate) is defined in respective securities, and there are many cases that it is difficult to trade all of the securities which were selected at the same time, within a scope of funds of respective investors. Therefor, the trustee such as trust banks securitizes the investment issues which were selected by respective investors and funds which were entrusted from the respective investors, and carries out actual fund operations by entrusting the securities to the operators.

Here, the securitization means a technique in which, a whole or a part of entrusted funds is set as face values thereof, and as to the selected respective securities, a security which defines an entire incorporation ratio taking selected ratio and exchangeable unit in the market into consideration is set, and actual operation of this security is entrusted to operators. Alternatively, there may be an embodiment in which issues of quantity which is less than the exchange unit can be made to be incorporated, and the securities which quantity is less than the exchange unit are purchased, and returns due to price movement on that portion are assumed by the trustee.

When a predetermined operation term is expired, the trustee receives results of operations from the operators, and withdraws trustee fees from the results of operations. Thereafter, respective investors receive the results of operations (returns) in accordance with initial investment amounts and the issues of securities which were selected by himself/herself and ratios.

As described above, in case that the technique of securitization is adopted, the investor can carry out diversified investments which seem to be impossible within a scope of funds on hand, and the trustee can obtain commission income by providing methods therefor.

As shown at the upper left of FIG. 7, there are three investors of x, y and z here. The investor x has 1,000,000 yen as total investment amount, and wishes to invest 200,000 yen out of then in a stock a, 300,000 yen in a stock b, and 500,000 yen in a stock c, and gives out an order to a trust bank A. The investor y has 2,000,000 yen as total investment amount, and wishes to invest 600,000 yen out of then in the stock a, 800,000 yen in the stock c and 600,000 yen in TOPIX (Tokyo Stock Exchange Stock Price Index) interlock type ETF (stock price index type Exchange Trade Fund), and gives out an order to the trust bank A. The investor z has 2,000,000 yen as total investment amount, and wishes to invest 400,000 yen out of then in the TOPIX interlock type ETF, 600,000 yen in a ¥-TIBOR (yen-dominated Tokyo Interbank Offered Rate) interlock debenture, and 1,000,000 yen in $-LIBOR (dollar-dominated London Interbank Offered Rate) interlock debenture, and gives out an order to the trust bank A. By these orders, the trust bank A accepts on trust of total amount of 5,000,000 yen, and its breakdown is as shown at the upper center of FIG. 7.

Here, a date when the orders are processed is assumed to be October 1, and as shown at the upper right of FIG. 7, an exchange unit at a stage of this date is assumed to be 1000 stocks all as to the stocks, 100 unit for ETF, 1 yen for the TIBOR interlock debenture, and 1 dollar for the LIBOR interlock debenture.

Further; unit price of respective securities at the stage of October 1, as shown under the exchange unit in FIG. 7, is assumed to be 100 yen for the stock a, 200 yen for the stock b, 250 yen for the stock c, and 1000 yen for the ETF. Based upon these, for example, exchange unit on the occasion of purchasing the stock b in the market becomes 200,000 yen, and it is impossible to apply the entrusted content (invest 300,000 yen in the stock b, out of 5,000,000 yen) to the operation as it is. Then, by use of the securitization, allocation is carried out in such a manner that, as shown in the figure, 400,000 yen is invested in the stock b and 1,250,000 yen is invested in the stock c.

The security which was set in this manner is to be sent for operations to the operators for 3 months until December 28, and price movement during this period is as shown in FIG. 7.

Here, commission charges which the trust bank A receives (withdraws from actual performance of the operations of the security), as shown at the lower part of FIG. 7, are assumed to be 3% of the initial investment amount in case of the stocks, and 4% in case of ETF and interest rate interlock debenture.

The return which the investor x finally receives is 220,000 yen as the actual performance since the stock price as to the stock a becomes 1.1 times, and by subtracting the commission charge (6,000 yen) of 3% of the initial investment amount from there, 214,000 yen. In the same manner, as the returns, 261,000 yen as to the stock b, and 585,000 yen as to the stock c are obtained and therefore, total returns become 1,060,000 yen.

The investor y obtains 636,000 yen as the return of the ETF since the commission charge is 4% of the initial investment amount, i.e., 24,000 yen which is subtracted from 660,000 yen as the actual performance, and since the same calculation is carried out as in the case of the investor x as to the stocks a and b, and obtains 2,214,000 yen as the total return.

The investor z, although as to ETF, the same calculation is carried out as in the case of the investor y, obtains the return of 576,750 yen as to TIBOR interlock debenture, since interest rate at the expiration date is 0.5% per annum (since the investment term is 3 months, the interest rate during this period is 0.125%) and the commission charge is 4%. As to the LIBOR interlock debenture, the interest rate at the expiration date is 4% per annum and the commission charge is 4% but a foreign exchange profit is 10%, and therefore, the return becomes 1,071,000 yen. From these, the total return becomes 2,071,750 yen.

As described above, the diversified investment which is impossible for an individual due to the relation to the exchange unit becomes possible by adopting the technique of securitization by the trustee side, and it becomes possible for the trustee to obtain a part of the actual performance of the operations of the security as the commission charge.

According to the embodiments of the invention, obtained is an advantage that transparency necessary for investors who provides funds in securities to carry out investment analysis is improved.

Alternatively, according to the embodiments of the invention, obtained is an advantage that satisfaction level of investors who wish to select issues to be invested by themselves is improved.

What is claimed is:

1. A system for providing securities including a plurality of investment issues comprising:
an investment analysis management unit adapted to accept investment analysis which are decided by an analyst and for deciding investments for individual investment issues and to store in a memory device;
an investment issue management unit adopted to accept a plurality of investment issues and funding amounts for the plurality of investment issues and investment ratios corresponding to the investment analysis which are designated by an investor and to store in the memory device;
an investment amount calculation unit adapted to read out from the memory device the funding amount and the investment ratios corresponding to the plurality of investment issues which are designated by the investor and to calculate investment amount of individual investment issues which are included in the plurality of investment issues based upon the funding amount and the investment ratio; and
an investment amount output unit adapted to output investment amount of the individual investment issues.

2. The system of claim 1 wherein, the memory device stores the investment analysis in accordance with each of the plurality of analysts, and the investment amount calculation unit calculates the investment amount of the individual investment issues, based upon investment analysis which correspond to the analyst who is designated by the investor.

3. The system of claim 1 further comprising a trading unit adapted to trade the plurality of investment issues, based upon, the investment amount of the individual investment issues.

4. The system of claim 1 wherein, the investment amount calculation unit re-calculates the investment amount of the individual investment issues, in case of accepting change of the plurality of investment issues by the investor or change of the investment ratio by the investor or change of the investment amount by the investor or change of the investment analysis by the analyst.

5. The system of claim 1 wherein, the memory device, in accordance with each of the plurality of investors, stores the funding amount and the plurality of investment issues and the investment ratios.

6. The system of claim 1 further comprising an operation result calculation unit adapted to calculate operation results in accordance with the plurality of investment issues and the investment ratios, in case that a predetermined operation term is expired, and an operation result output unit adapted to output the operation results.

7. The system of claim 1 wherein, the investment amount calculation unit calculates a total value of the investment amounts of individual investment issues of the investor, in case of accepting such a request from the investor that a part of the funding amount is allocated too cash, and subtracts the total value from the funding amount to calculate an allocation amount to cash.

8. The system of claim 1 wherein, the investment analysis management unit displays the investment analysis on a display screen which the investor can see.

9. A method for providing securities including a plurality of investment issues comprising:
a first step of accepting investment analysis which are decided by an analyst and for deciding investments for individual investment issues and of storing in a memory device;
a second step of accepting a plurality of investment issues and funding amounts for the plurality of investment issues and investment ratios corresponding to the investment analysis which are designated by an investor and of storing in the memory device;
a third step of reading out from the memory device the funding amount and the investment ratios corresponding to the plurality of investment issues which are designated by the investor and of calculating investment amount of individual investment issues which are included in the plurality of investment issues based upon the funding amount and the investment ratio; and
a fourth step of outputting investment amount of the individual investment issues.

10. A system for providing securities including a plurality of investment issues comprising:
an investment analysis management unit adapted to accept investment analysis and investment ratios corresponding to the investment analysis which are decided by an analyst and for deciding investments for individual investment issues and to store in a memory device;
an investment issue management unit adopted to accept a plurality of investment issues and funding amounts for the plurality of investment issues which are designated by an investor and to store in the memory device;
an investment amount calculation unit adapted to read out from the memory device the funding amount and the investment ratios corresponding to the plurality of investment issues which are designated by the investor and to calculate investment amount of individual investment issues which are included in the plurality of investment issues based upon the funding amount and the investment ratio; and
an investment amount output unit adapted to output investment amount of the individual investment issues.

11. The system of claim 10 wherein, the investment amount calculation unit re-calculates the investment amount of the individual investment issues, in case of accepting change of the plurality of investment issues by the investor or change of the investment ratio by the analyst or change of the funding amount by the investor or change of the investment analysis by the analyst.

12. A method for providing securities including a plurality of investment issues comprising:
a first step of accepting investment analysis and investment ratios corresponding to the investment analysis which are decided by an analyst and for deciding investments for individual investment issues and of storing in a memory device;
a second step of accepting a plurality of investment issues and funding amounts for the plurality of investment issues which are designated by an investor and of storing in the memory device;
a third step of reading out from the memory device the funding amount and the investment ratios corresponding to the plurality of investment issues which are designated by the investor and of calculating investment amount of individual investment issues which are included in the plurality of investment issues based upon the funding amount and the investment ratio; and
a fourth step of outputting investment amount of the individual investment issues.

13. A method for providing securities including a plurality of investment issues comprising:
a first step of preparing securities in which a whole or a part of financial resources entrusted by investors is set as face values thereof, and as to the investment issues selected by the investor an entire incorporating ratio which takes a ratio which is selected by the investor into consideration is defined; and
a second step of redeeming operation results in accordance with the selected issue and ratio to the investor when a predetermined term is expired.

14. The method of claim 13 further comprising:
a third step of accepting investment analysis which are decided by an analyst and for deciding investments for individual investment issues and of storing in a memory device;
a fourth step of accepting a plurality of investment issues and funding amounts for the plurality of investment issues and investment ratios corresponding to the investment analysis which are designated by an investor and of storing in the memory device;
a fifth step of reading out from the memory device the funding amount and the investment ratios corresponding to the plurality of investment issues which are designated by the investor and of calculating investment amount of individual investment issues which are included in the plurality of investment issues based upon the funding amount and the investment ratio;
a sixth step of outputting investment amount of the individual investment issues; and
a seventh step of preparing securities which are defined by an incorporating ration based upon the investment amount of the individual investment issues and of managing security operations.
